(19) United States
(12) Patent Application Publication
(10) Pub. No.: US 2015/0257367 A1
(43) Pub. Date: Sep. 17, 2015

(54) Illuminated Animal Exercise Device and Animal Exercise Apparatus

(71) Applicant: Doskocil Manufacturing Company, Inc., Arlington, TX (US)

(72) Inventor: Jack William Renforth, Azle, TX (US)

(21) Appl. No.: 14/644,618

(22) Filed: Mar. 11, 2015

Related U.S. Application Data
(60) Provisional application No. 61/951,161, filed on Mar. 11, 2014.

(51) Int. Cl. A01K 15/02; F21V 23/04; F21V 11/08; A01K 29/00; F21V 33/00

(52) U.S. Cl. CPC A01K 15/027; A01K 29/00; A01K 15/025; A01K 15/021; F21V 33/008; F21V 11/08; F21V 23/04; F21W 2131/40

(57) ABSTRACT

An animal exercise device and animal exercise apparatus provide a beam of collimated light whose impingement on a surface can be chased by a cat for beneficial. The animal exercise device can be mounted upon an elongated wand to form the animal exercise apparatus. The animal exercise device includes a strap that is extendable around the wand or another device, and this enables the illuminated animal exercise device to be mounted to the wand or such other device to enable the impingement of the collimated light to be moved to interest and exercise the cat

### CROSS-REFERENCE TO RELATED APPLICATION

The instant application claims priority from U.S. Provisional Patent Application Ser. No. 61/951,161 filed Mar. 11, 2014, the disclosures of which are incorporated herein by reference.

### BACKGROUND

1. Field

The disclosed and claimed concept relates generally to animal-related devices, and more particularly, to an illuminated animal exercise device and animal exercise apparatus.

2. Related Art

Numerous types of animal toys and exercise-related devices are known to exist. It is known to be desirable for animals to exercise for reasons of health and for other reasons. Animals become highly motivated to exercise when the exercise involves play or other interaction with humans. In some animals, such as certain dogs, a retrieval instinct will cause the animal to fetch and retrieve a thrown ball, stick, etc., which will cause the animal to engage in beneficial exercise.

Certain animals, however, such as cats, do not have an innate retrieving instinct and thus will not engage meaningfully in a game of “fetch”. It is known, however, that cats possess other natural instincts. For example, a cat's defensive instincts will cause the cat to investigate certain sounds that may be heard inside the household. Moreover, cats possess a visual and auditory chase instinct, and cats sometimes prefer to indulge the chase instinct more than the actual catching of the prey.

### SUMMARY

An improved animal exercise device and animal exercise apparatus provide a beam of collimated light whose impingement on a surface can be chased by a cat for beneficial. The animal exercise device can be mounted upon an elongated wand to form the animal exercise apparatus. The animal exercise device includes a strap that is extendable around the wand or another device, and this enables the illuminated animal exercise device to be mounted to the wand or such other device to enable the impingement of the collimated light to be moved to interest and exercise the cat.

Accordingly, an aspect of the disclosed and claimed concept is to provide an improved illuminated animal exercise device that is usable to gain the interest of an animal and to thereby induce the animal to exercise by chasing an impingement of light that moves along a surface.

Another aspect of the disclosed and claimed concept is to provide such an illuminated animal exercise device that is attachable to other devices to form an illuminated animal exercise apparatus.

Other aspects of the disclosed and claimed concept are provided by an improved animal exercise device that can be generally said to include a support, a light source situated on the support, the light source being structured to output collimated light, and the support comprising a base and a strap, the light source being situated on the base, a first portion of the strap having a first connection with the base, the strap being structured to be extendable around another object and to make a second connection with the base and to attach the light source to such other object.

### BRIEF DESCRIPTION OF THE DRAWINGS

A further understanding of the disclosed and claimed concept can be gained from the following Description when read in conjunction with the accompanying drawings in which:

FIG. 1 is a perspective view of an improved illuminated animal exercise device in accordance with the disclosed and claimed concept situated in proximity to a wand;

FIG. 2 is a view similar to FIG. 1, except depicting the animal exercise device being affixed to the wand to form an improved animal exercise apparatus in accordance with the disclosed and claimed concept;

FIG. 3 is another perspective view similar to FIG. 1;

FIG. 4 is another perspective view similar to FIG. 2;

FIG. 5 is a side elevational view of a beam of collimated light from the animal exercise device impinging on a wall;

FIG. 6 is a perspective view of the animal exercise device; and

FIG. 7 is another perspective view of the animal exercise device.

Similar numerals refer to similar parts throughout the specification.

### DESCRIPTION

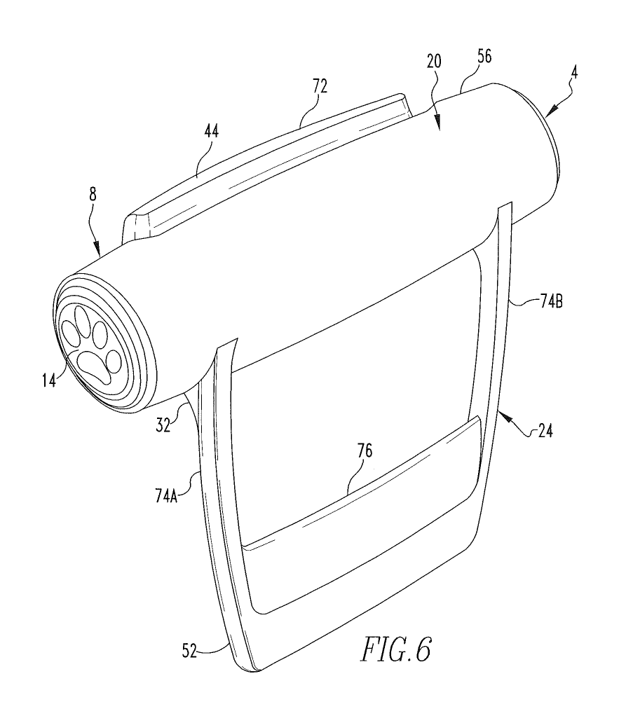

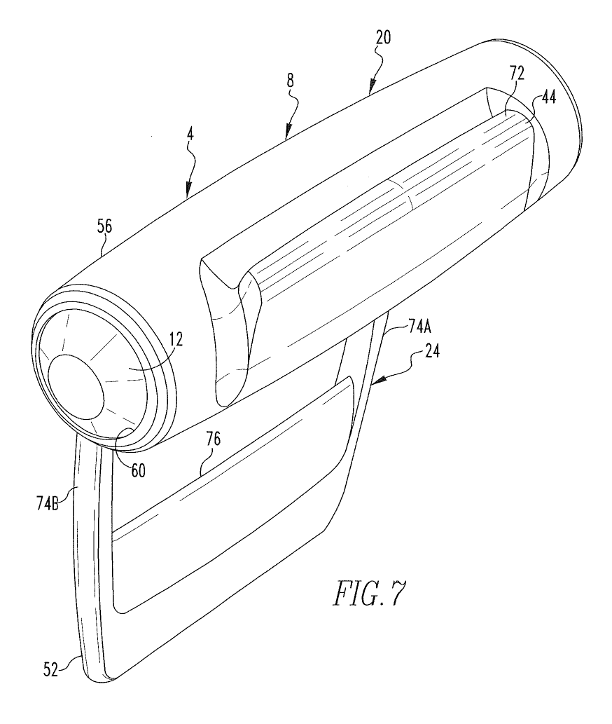

An improved animal exercise device 4 is depicted in FIGS. 6 and 7 and is configured to selectively output a beam of collimated light 16 (FIG. 5) that is usable with an animal to induce exercise, play, etc. with the animal. More particularly, when the beam of collimated light 16 is directed onto a surface 22 such as a floor or a wall, the animal desirably will visually notice and observe an impingement 26 of the beam of collimated light 16 on the floor or other surface 22 as being a circle or dot (or other shape) of light. The animal's natural chase instinct will cause the animal to touch the light impingement 26 in order to try to catch it. As the user moves the animal exercise device 4, the position of the impingement 26 is likewise caused to move, which further heightens the interest of the animal in the light impingement 26. As the animal continues to chase the light impingement 26, the animal is exercised and its natural chase instinct is likewise indulged.

If, during such chase, the animal moves into the beam of collimated light 16 and thus interrupts its impingement 26 onto the wall or floor, the impingement 26 will appear to the animal to have vanished. The impingement 26 will eventually reappear once the animal no longer interrupts the impingement 26. Such disappearance and reappearance of the impingement 26 further increases the interest of the animal in the impingement 26.

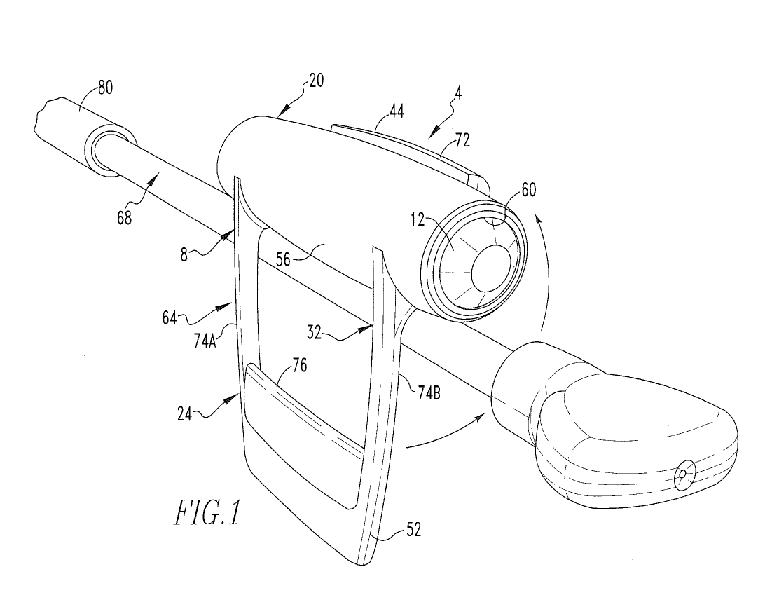

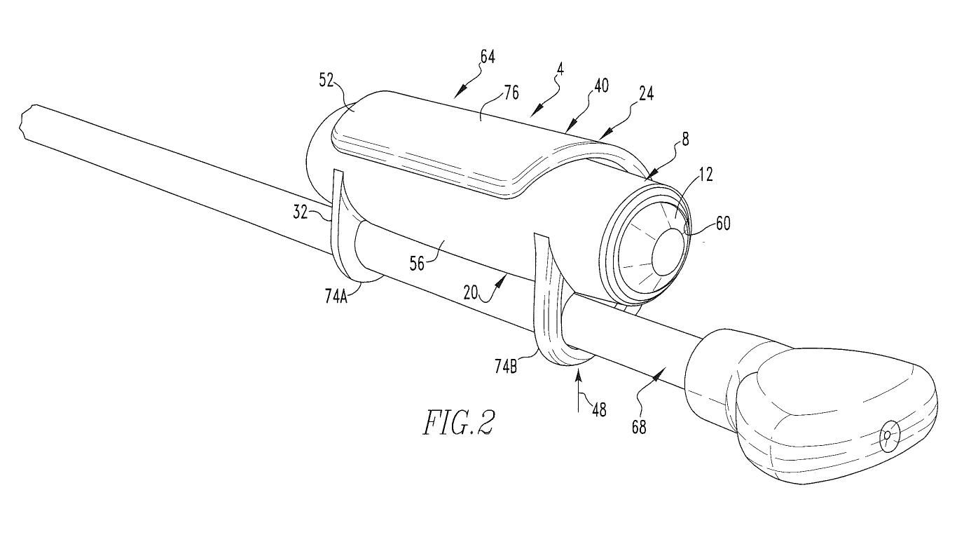

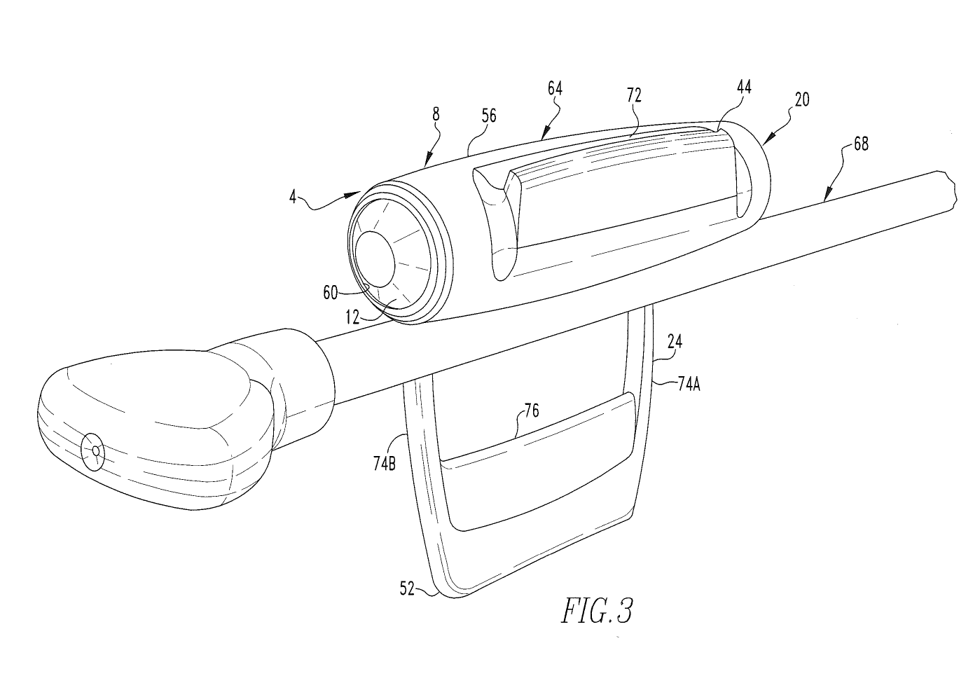

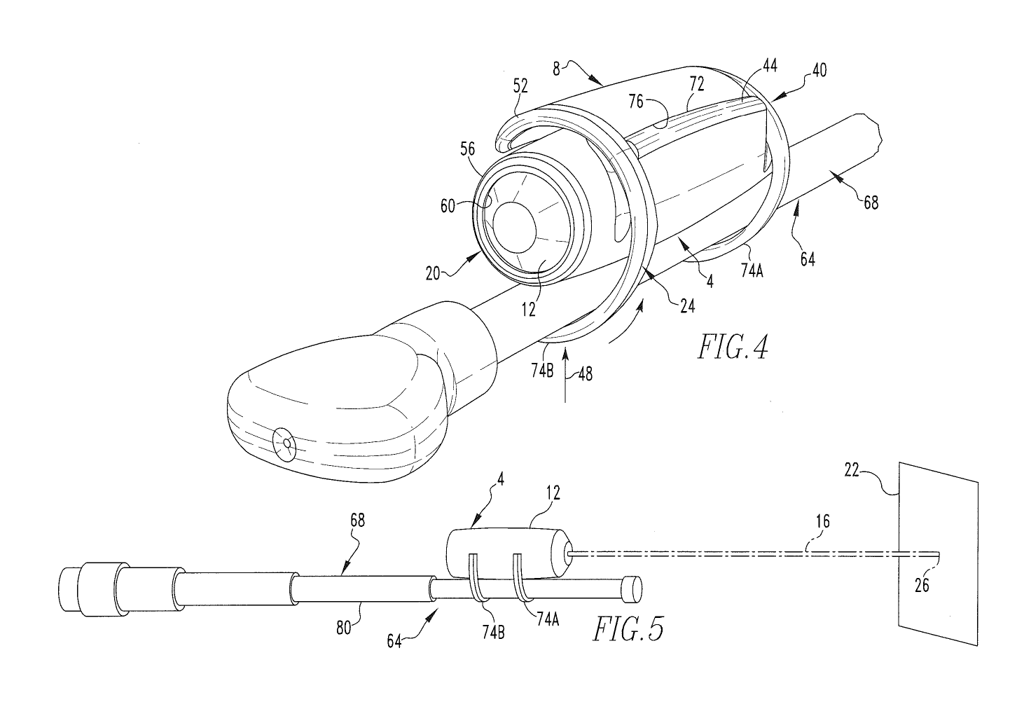

The animal exercise device 4 is usable on its own but is also usable in conjunction with another object which, in the depicted exemplary embodiment of FIGS. 1-5, is an elongated wand 68. The animal exercise device 4 being mounted to the wand 68 forms an improved animal exercise apparatus 64 that is likewise in conjunction with the disclosed and claimed concept. One version of the exemplary elongated wand 68 that is depicted in FIG. 5 is collapsibly movable between a collapsed position and an extended position (depicted). It is understood, however, that the animal exercise apparatus 64 in other embodiments could employ the animal exercise device 4 in a condition attached to any of a wide variety of objects to form another such animal exercise apparatus. Such objects are preferably movable to enable the impingement 26 to be movable to heighten the animal's interest.

The animal exercise device 4 can be said to include a support 8 and a light source 12, with the light source 12 being situated on the support 8. As suggested above, the light source 12 is configured to output the beam of collimated light 16, which is a beam of electromagnetic energy having minimal divergence and whose impingement 26 on a surface 22 of another object is visible, either to a human or to an animal The beam of collimated light 16 thus is generally in the form of a beam of laser light, but in the depicted exemplary embodiment the light source 12 employs extremely bright light emitting diodes (LEDs) since true lasers are regulated under governmental authority.

The light source 12 is an off-the-shelf unit that can be purchased from any of a wide variety of manufacturers and that is operated by a battery. The light source 12 additionally includes a pushbutton switch 14 to change the light source 12 between an ON condition and an OFF condition. While the beam of collimated light 16 is described herein as being minimally divergent, it is understood that any non-divergent beam of light can be referred to as being a beam of collimated light regardless of the method in which the beam of light is made essentially non-divergent.

The support 8 can be generally said to include a base 20 and a strap 24, with a first portion of the strap 24 having a first connection 32 with the base 20. The strap 24 extends generally away from the base 20 and has a free end 52 opposite the first connection 32. In the depicted exemplary embodiment, the support 8, and especially the strap 24, is formed of an elastomeric material whereby the strap 24 is flexible and elastic.

The base 20 can be said to include a hollow sleeve 56 having an interior region 60 within which the light source 12 is situated. The base 20 further includes a connector 44 that is situated on the sleeve 56 at an exterior thereof and that is cooperable with the free end 52 of the strap 24. More specifically, the exemplary connector 44 is in the form of a protrusion that protrudes outwardly from the sleeve 56 and which includes a ledge 72.

The strap 24 includes a pair of legs 74A and 74B and further includes at its free end 52 a lug 76. In the depicted exemplary embodiment, the lug 76 extends between and is interposed between the free ends of the pair of legs 74A and 74B. The lug 76 is engageable with the ledge 72 to cause the strap 24 to make a second connection 40 with the base 20. The ends of the pair of legs 74A and 74B opposite the lug 76 form the first connection 32 with the base 20. It is understood that other types of attachment devices can be employed to cause the strap 24 to make the second connection 40 with the base 20. Moreover, it understood that other attachment methodologies may be employed to affix the light source 12 to another object, and such other attachment methodologies would be considered to be within the spirit of the present concept.

When the free end 52 of the strap 24 is connected with the ledge 72 to make the second connection 40 between the ledge 72 and the lug 76, the strap 24 is in a state of elastic tension. That is, the strap 24 is of a length whereby it can be wrapped or extended about any of a variety of objects and, in so doing, will need to be elastically stretched in order to make the second connection 40. Such tension in the strap 24 results in radially-oriented compressive forces 48 being applied by the strap 24 to the other object such as the elongated wand 68, and such compressive forces 48 result in friction between the strap 24 and the wand 68 which retains the animal exercise device 4 on the wand 68. Moreover, since the strap 24 is formed of an elastic material such as a rubber-like material, the material of the strap 24 and the elongated wand 68 (or other structure) have a high coefficient of static friction therebetween, which further helps to retain the animal exercise device 4 on the wand 68 or other structure.

As can be understood from FIG. 5, the wand 68 includes a handle 80 at a first end thereof. The animal exercise device 4 is depicted as being attached to the wand 68 generally at another end that is opposite the handle 80. The animal exercise device 4 can be installed on the wand 68 at any location thereon and, as set forth above, can be mounted to any of a variety of other objects by wrapping the strap 24 around the wand 68 or such other object and by connecting the lug 76 with the ledge 72 (which can together be said to faun the connector 44) to make the second connection 40.

In the depicted exemplary embodiment, the animal exercise device 4 can be switched to its ON condition whereby it outputs the beam of collimated light 16 in both the extended and collapsed configurations of the handle 80. Other variations of the foregoing will be apparent and will be within the scope of the disclosed and claimed concept.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. An animal exercise device comprising:
a support;
a light source situated on the support, the light source being structured to output collimated light; and
the support comprising a base and a strap, the light source being situated on the base, a first portion of the strap having a first connection with the base, the strap being structured to be extendable around another object and to make a second connection with the base and to attach the light source to the another object.

2. The device of claim 1 wherein the support further comprises a connector, the strap being connectable with the connector to make a second connection with the base.

3. The device of claim 2 wherein the strap is formed of an elastomeric material and is structured to be in a state of tension when the strap extends around the another object and is connected with the connector, the strap in such condition being structured engage the another object and to apply a compressive force to the another object.

4. The device of claim 3 wherein the strap extends from the base and has a free end that is connectable with the connector to make a second connection with the base.

5. The device of claim 4 wherein the base comprises an elongated sleeve, the light source being situated in an interior region of the sleeve.

6. The device of claim 5 wherein the strap comprises a pair of legs and a lug, the lug being interposed between the pair of legs and being situated at the free ends.

7. The device of claim 6 wherein the strap is movable between an attached condition connected with the connector and a detached condition disconnected from the connector, and wherein the lug extends approximately parallel with the sleeve in the attached condition.

8. The device of claim 7 wherein the connector includes a ledge, the lug being received on the ledge and retained thereon when strap is in the attached condition.

9. The device of claim 1 wherein the light source is structured to output collimated light from a first end thereof, and wherein the light source comprises a pushbutton switch on a second end thereof opposite the first end.

10. An animal exercise apparatus comprising the animal exercise device of claim 1, and further comprising an elongated wand as the another object, the animal exercise device being mounted to the wand.
